(19) United States
(12) Patent Application Publication
(10) Pub. No.: US 2025/0196319 A1
(43) Pub. Date: Jun. 19, 2025

(54) MULTI-LAYER DRIVING DEVICE, MOVING ROBOTS FOR GREENHOUSES EQUIPPED WITH THEM, AND CONTROL METHOD THEREOF

(71) Applicant: ELECTRONICS AND TELECOMMUNICATIONS RESEARCH INSTITUTE, Daejeon (KR)

(72) Inventors: Lae Kyoung LEE, Daejeon (KR); Su Yong AN, Daejeon (KR)

(21) Appl. No.: 18/986,903

(22) Filed: Dec. 19, 2024

(30) Foreign Application Priority Data
Dec. 19, 2023 (KR) 10-2023-0185873
Nov. 20, 2024 (KR) 10-2024-0166718

(51) Int. Cl. B25J 5/02; A01G 9/14; B25J 5/00; B25J 19/00

(52) U.S. Cl. CPC B25J 5/02; B25J 5/007; B25J 19/0025; A01G 9/143

(57) ABSTRACT

The present invention provides a multi-layer driving device including a travel driving part disposed on a movable main body to perform a level ground travel; a rail driving part disposed at a different height relative to the travel driving part to perform a rail travel along a rail disposed on a ground surface; and a travel switching part enabling the level ground travel or the rail travel by causing the rail driving part to protrude toward the ground surface or retract according to whether the rail is located on a movement path of the movable main body.

### CROSS-REFERENCE TO RELATED APPLICATIONS

This application claims priority from and the benefit under 35 U.S.C. § 119 of Korean Patent Application No. 10-2023-0185873, filed on Dec. 19, 2023, and Korean Patent Application No. 10-2024-0166718, filed on Nov. 20, 2024, in the Korean Intellectual Property Office, the entire disclosure of which is incorporated by reference for all purposes.

### BACKGROUND

### 1. Field of the Invention

The present invention relates to a multi-layer driving device, a moving robot for greenhouses that is equipped with the same, and a control method thereof capable of selectively performing a level ground travel and a rail travel.

### 2. Description of Related Art

Generally, nowadays, due to the development of industrial technology, agricultural facilities such as greenhouses are installed, and it is possible to provide crops such as fruits, vegetables, and flowers to consumers even in winter.

In such agricultural facilities, in order to grow crops, nutrient solutions (water, pesticides, nutrients, etc.) are sprayed to continuously supply moisture to the crops, prevent diseases and insect pests, and supply nutrients to the crops.

In the past, when spraying nutrient solutions on crops, manpower was used to spray nutrient solutions.

However, in recent years, nutrient solution spraying devices that automatically spray nutrient solutions on crops have been installed in agricultural facilities to automatically spray nutrient solutions.

The conventional nutrient solution spraying devices that automatically spray nutrient solutions on crops have been published in Korean Utility Model Registration No. 20-0264576, Korean Patent Registration No. 10-1120490, Korean Unexamined Patent Application Publication No. 10-2000-0025511, etc.

In such nutrient solution spraying devices, rails are installed at the top of each furrow of an agricultural facility, and nutrient solution spraying devices are installed on each rail, so that each nutrient solution spraying device moves along the rail and sprays nutrient solutions on crops.

However, since agricultural facilities must be built strong enough to support the loads of the nutrient solution spraying devices moving along the rails installed at the top, the rails or the like must be separately installed in the existing agricultural facilities, and the nutrient solution spraying devices must be separately installed for each furrow, the conventional nutrient solution spraying devices have problems in that installation costs of agricultural facilities increase, and installation in the existing agricultural facilities is difficult.

The related art of the present invention has been disclosed in Korean Patent Registration No. 10-1389012 (Published Date: Apr. 25, 2014, Title of Invention: Agricultural robot for pest control).

### SUMMARY OF THE INVENTION

The present invention is directed to providing a multi-layer driving device, a moving robot for greenhouses that is equipped with the same, and a control method thereof capable of selectively performing a level ground travel and a rail travel and capable of, when traveling inside a greenhouse in which a hot water pipe is installed, performing the rail travel along a rail formed by the hot water pipe and spraying a nutrient solution while freely moving along trenches formed between crops.

According to an aspect of the present invention, there is provided a multi-layer driving device including a travel driving part disposed on a movable main body to perform a level ground travel; a rail driving part disposed at a different height relative to the travel driving part to perform a rail travel along a rail disposed on a ground surface; and a travel switching part enabling the level ground travel or the rail travel by causing the rail driving part to protrude toward the ground surface or retract according to whether the rail is located on a movement path of the movable main body.

The travel driving part of the present invention may include a plurality of driving wheels disposed on the movable main body; a driving motor providing power to rotating shafts of the driving wheels; and a driving switching part controlling an advancing direction and a rotation speed of the power provided from the driving motor and transmitting the power to the rotating shafts of the driving wheels.

The multi-layer driving device of the present invention may further include a swerve driving part connecting the plurality of driving wheels to each other so that the plurality of driving wheels are disposed in the same direction and swerving the plurality of driving wheels in the same direction to adjust an advancing direction of the movable main body.

The swerve driving part of the present invention may include a swerve plate disposed on the movable main body; a swerve motor disposed on the swerve plate; and a power transmission part transmitting power provided from the swerve motor to steering shafts of the driving wheels to swerve the plurality of driving wheels in the same direction.

The power transmission part of the present invention may include a driving pulley installed on a driving shaft of a swerve switching part connected to the swerve motor; a driven pulley installed on a swerve shaft of each of the plurality of driving wheels; and a swerve belt installed to surround the driving pulley and the driven pulley to transmit the power provided from the swerve motor to the plurality of driving wheels.

The swerve driving part of the present invention may further include a tension maintaining part maintaining tension of the swerve belt to prevent slippage between the driving pulley or the driven pulley and the swerve belt.!

The tension maintaining part of the present invention may include a protruding pulley disposed in a direction toward an inner side of the movable main body relative to the driven pulley and having the swerve belt wound therearound to press the swerve belt toward the inner side of the movable main body; and a protruding part protruding from the swerve plate to support the protruding pulley.

The rail driving part of the present invention may include a rail plate installed to be able to protrude from the movable main body or retract; a plurality of rail wheels disposed on the rail plate; a rail motor providing power to the rail wheels; and a rail belt transmitting the power provided from the rail motor to the plurality of rail wheels.

The travel switching part of the present invention may include a cylinder member disposed on the movable main body; a rod member installed to be able to protrude from the cylinder member and connected to the rail plate; and a switching motor causing the rod member to protrude from the movable main body or retract.

The multi-layer driving device of the present invention may further include a steering driving part switching an arrangement direction of a rail switching part while driving the travel switching part in a forward direction or a reverse direction to, when the movable main body enters the rail, align directions of the rail driving part and the rail to be the same.

The steering driving part of the present invention may include a steering plate supporting the cylinder member and rotatably installed on the movable main body; and a steering motor having a driving shaft gear-connected to the steering plate to provide forward or reverse power to the steering plate.

According to another aspect of the present invention, there is provided a moving robot for greenhouses that is equipped with a multi-layer driving device including a travel driving part disposed on a movable main body to perform a level ground travel; a rail driving part disposed at a different height relative to the travel driving part to perform a rail travel along a rail disposed on a ground surface; and a travel switching part enabling the level ground travel or the rail travel by causing the rail driving part to protrude toward the ground surface or retract according to whether the rail is located on a movement path of the movable main body.

According to still another aspect of the present invention, there is provided a control method of a moving robot for greenhouses that is equipped with a multi-layer driving device, the control method including: (a) starting a level ground travel of a movable main body having a travel driving part performing the level ground travel, a rail driving part performing a rail travel, a travel switching part controlling driving of the travel driving part or the rail driving part, and a steering driving part changing a direction of the rail driving part; (b) in response to the starting of the level ground travel of the movable main body, measuring whether a rail is located on a travel path of the movable main body and determining whether to start a rail travel; (c) in response to the rail being measured as located on the travel path of the movable main body, determining whether arrangement directions of the rail and the rail driving part are different from each other; and (d) in response to the arrangement directions of the rail and the rail driving part being determined as different from each other, transmitting a driving signal to the steering driving part and aligning the arrangement direction of the rail driving part to be the same as the arrangement direction of the rail.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a perspective view illustrating a multi-layer driving device according to one embodiment of the present invention;

FIG. 2 is an exploded perspective view illustrating a rail driving part of the multi-layer driving device according to one embodiment of the present invention;

FIG. 3 is an exploded perspective view illustrating a swerve driving part of the multi-layer driving device according to one embodiment of the present invention;

FIG. 4 is a perspective view illustrating a travel switching part and a steering driving part of the multi-layer driving device according to one embodiment of the present invention;

FIG. 5 is a perspective view illustrating a power transmission part and a tension maintaining part of the multi-layer driving device according to one embodiment of the present invention;

FIG. 6 is a perspective view illustrating a swerve driving part of the multi-layer driving device according to one embodiment of the present invention;

FIG. 7 is a perspective view illustrating a rail driving part of the multi-layer driving device according to one embodiment of the present invention;

FIG. 8 is an operation state view illustrating the rail driving part of the multi-layer driving device according to one embodiment of the present invention;

FIG. 9 is a perspective view illustrating an operation state of the rail driving part of the multi-layer driving device according to one embodiment of the present invention; and

FIG. 10 is a flowchart illustrating a control method of a moving robot for greenhouses that is equipped with a multi-layer driving device according to one embodiment of the present invention.

### DETAILED DESCRIPTION

Hereinafter, a multi-layer driving device, a moving robot for greenhouses that is equipped with the same, and a control method of the moving robot for greenhouses according to one embodiment of the present invention will be described with reference to the accompanying drawings.

In this process, thicknesses of lines or sizes of components illustrated in the drawings may be exaggerated for clarity and convenience of description.

Also, terms used below are terms defined in consideration of functions in the present invention and may be changed according to an intention or customary practice of a user or an operator.

Therefore, the terms should be defined based on the content throughout the present specification.

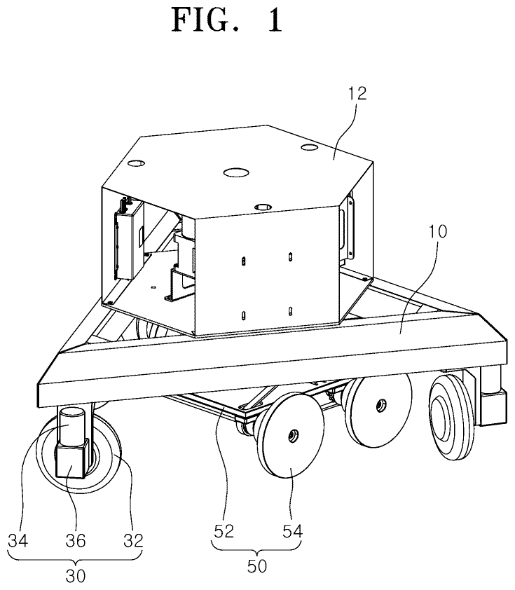

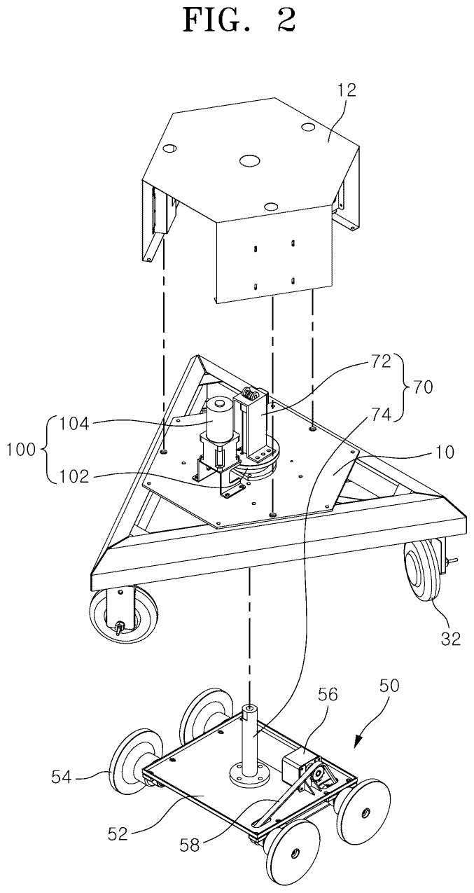

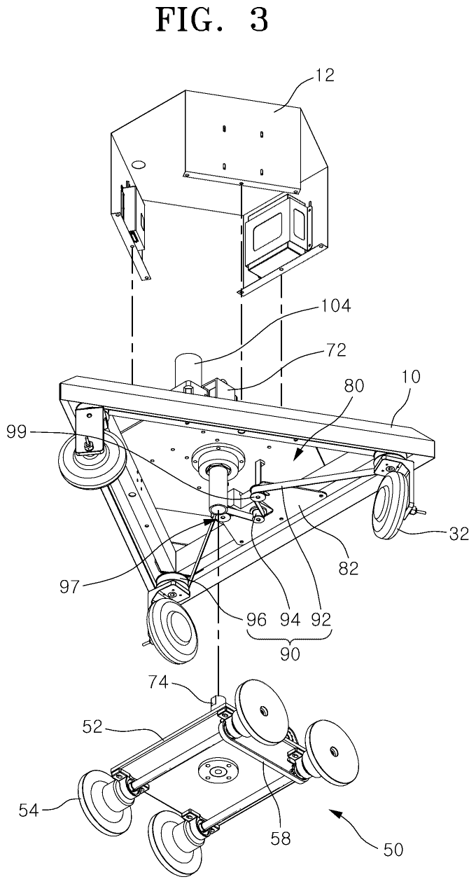

FIG. 1 is a perspective view illustrating a multi-layer driving device according to one embodiment of the present invention, FIG. 2 is an exploded perspective view illustrating a rail driving part of the multi-layer driving device according to one embodiment of the present invention, and FIG. 3 is an exploded perspective view illustrating a swerve driving part of the multi-layer driving device according to one embodiment of the present invention.

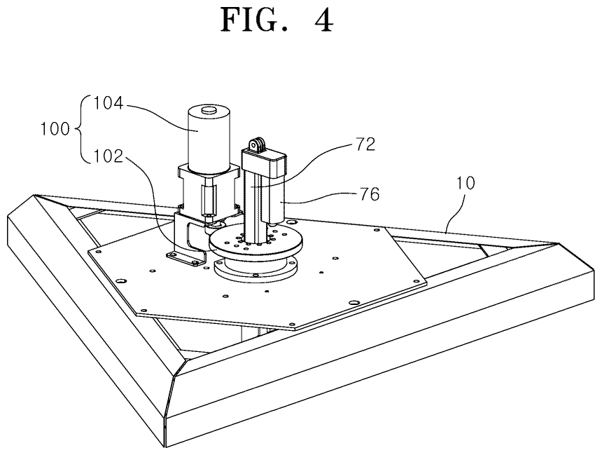

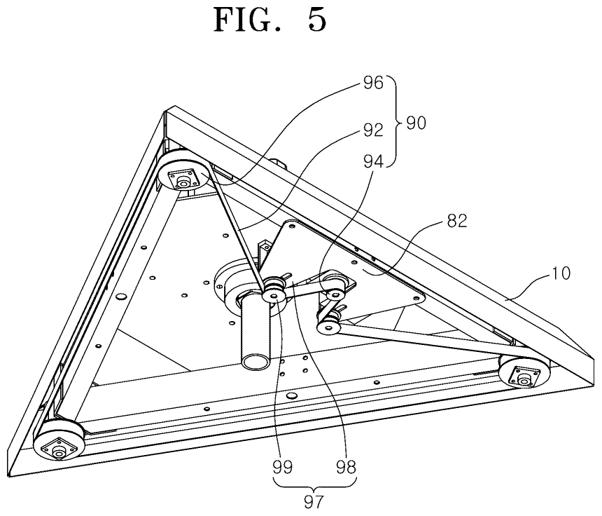

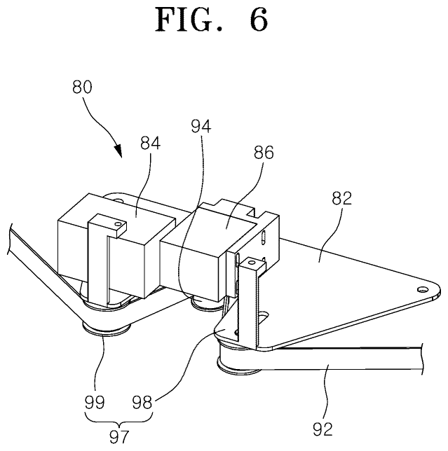

FIG. 4 is a perspective view illustrating a travel switching part and a steering driving part of the multi-layer driving device according to one embodiment of the present invention, FIG. 5 is a perspective view illustrating a power transmission part and a tension maintaining part of the multi-layer driving device according to one embodiment of the present invention, and FIG. 6 is a perspective view illustrating a swerve driving part of the multi-layer driving device according to one embodiment of the present invention.

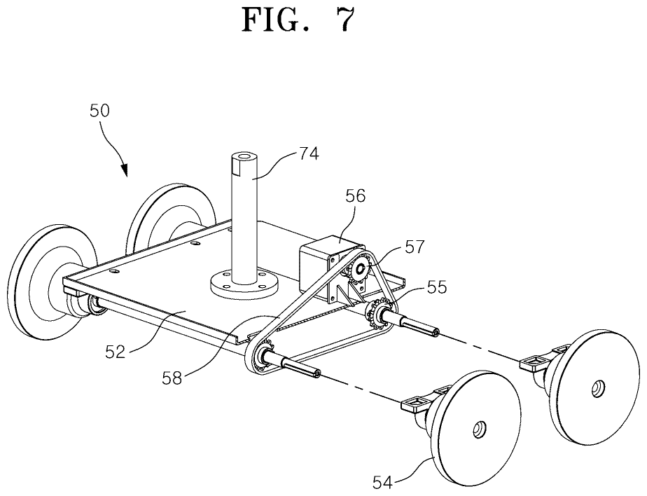

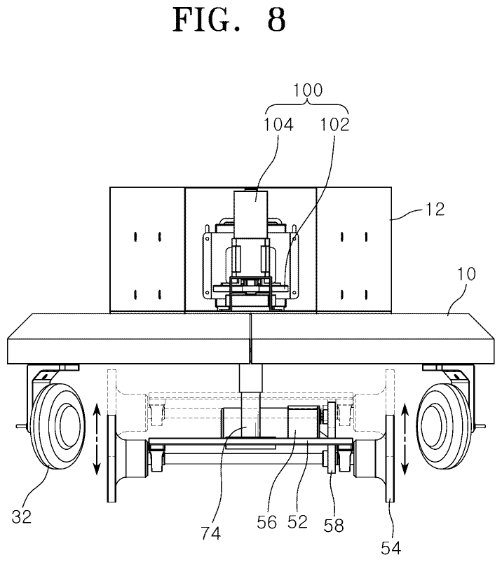

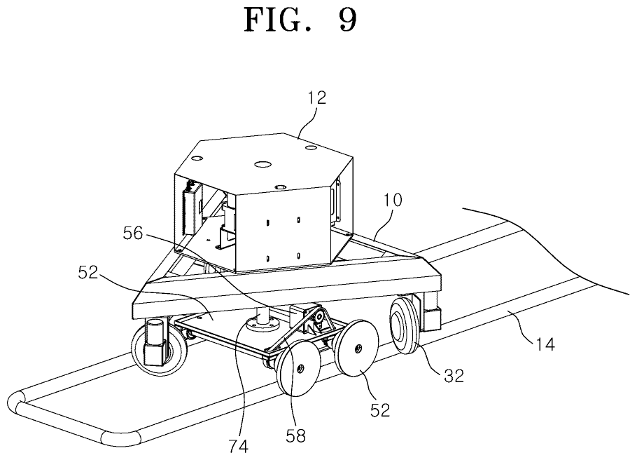

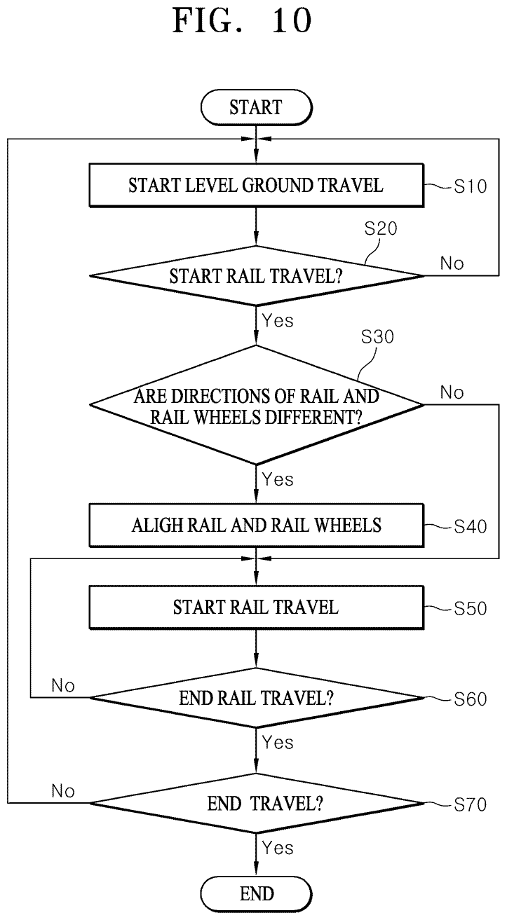

FIG. 7 is a perspective view illustrating a rail driving part of the multi-layer driving device according to one embodiment of the present invention, FIG. 8 is an operation state view illustrating the rail driving part of the multi-layer driving device according to one embodiment of the present invention, FIG. 9 is a perspective view illustrating an operation state of the rail driving part of the multi-layer driving device according to one embodiment of the present invention, and FIG. 10 is a flowchart illustrating a control method of a moving robot for greenhouses that is equipped with a multi-layer driving device according to one embodiment of the present invention.

Referring to FIGS. 1 to 10, a multi-layer driving device according to one embodiment of the present invention includes a travel driving part 30 disposed on a movable main body 10 to perform a level ground travel, a rail driving part 50 disposed at a different height relative to the travel driving part 30 to perform a rail travel along a rail disposed on a ground surface, a travel switching part 70 enabling the level ground travel or the rail travel by causing the rail driving part 50 to protrude toward the ground surface or retract according to whether the rail is located on a movement path of the movable main body 10, a swerve driving part 80 maintaining arrangement directions of a plurality of driving wheels 32 so that the driving wheels 32 are disposed in the same direction and swerving the plurality of driving wheels 32 in the same direction to adjust an advancing direction of the movable main body 10, and a steering driving part 100 switching an arrangement direction of the rail driving part 50 while driving the travel switching part 70 in a forward direction or a reverse direction to, when the movable main body 10 enters the rail, align directions of the rail driving part 50 and the rail to be the same.

Accordingly, when the movable main body 10 that has various devices, such as a pesticide spraying device, installed thereon and is installed on a moving robot for greenhouses travels along a rail formed by a hot water pipe 14 while traveling inside a greenhouse, the rail driving part 50 protrudes to a lower height than the travel driving part 30 due to an operation of the travel switching part 70, and as a result, the rail driving part 50 is seated on the hot water pipe 14 and performs a rail travel of the movable main body 10.

The rail driving part 50 of the present embodiment is formed with a narrower width than the travel driving part 30 and thus is able to, when passing through trenches formed between crops, move along the hot water pipe 14 laid in the trenches, and since a width between rail wheels 54 constituting the rail driving part 50 is formed to be equal or similar to a width of the hot water pipe 14, the rail travel can be performed along the rail formed by the hot water pipe 14.

The rail driving part 50 of the present embodiment may also be used in the level ground travel instead of the rail travel according to various topographical features of greenhouses, and when passing through a trench with a narrow width in which a rail is not laid, the moving robot may perform the rail travel along the trench with a narrow width due to an operation of the rail driving part 50 according to a driving signal transmitted from a controller.

The travel driving part 30 of the present embodiment may include the plurality of driving wheels 32 disposed on the movable main body 10, a driving motor 34 providing power to rotating shafts of the driving wheels 32, and a driving switching part 36 controlling an advancing direction and a rotation speed of the power provided from the driving motor 34 and transmitting the power to the rotating shafts of the driving wheels 32.

The movable main body 10 of the present embodiment is formed in the shape of a triangular plate and has three driving wheels 32 provided thereon by the driving wheels 32 being installed on each corner thereof, and as a result, when power is provided from the driving motor 34 installed on steering shafts of the driving wheels 32 and passes through the driving switching part 36 made of a gearbox, the power is transmitted to the rotating shafts of the driving wheels 32, and the level ground travel of the movable main body 10 is performed.

Advancing directions of the plurality of driving wheels 32 can be switched to various directions by an operation of the swerve driving part 80 of the present embodiment, and the swerve driving part 80 of the present embodiment may include a swerve plate 82 disposed on the movable main body 10, a swerve motor 84 disposed on the swerve plate 82, and a power transmission part 90 transmitting power provided from the swerve motor 84 to the steering shafts of the driving wheels 32 to swerve the plurality of driving wheels 32 in the same direction.

The power transmission part 90 of the present embodiment may include a driving pulley 94 installed on a driving shaft of a swerve switching part 86 connected to the swerve motor 84, a driven pulley 96 installed on a swerve shaft of each of the plurality of driving wheels 32, and a swerve belt 92 installed to surround the driving pulley 94 and the driven pulley 96 to transmit the power provided from the swerve motor 84 to the plurality of driving wheels 32.

Accordingly, when a traveling direction of the movable main body 10 is changed according to a driving signal provided from the controller, since a power supply is provided to the swerve motor 84, and forward or reverse power is transmitted from the swerve motor 84 to the steering shafts of the plurality of driving wheels 32 along the swerve belt 92, the advancing direction of the movable main body 10 can be adjusted as the plurality of driving wheels 32 simultaneously swerve in the forward or reverse direction.

The driving wheels 32 of the present embodiment are rotatably installed on the steering shafts vertically extending from the movable main body 10, and the driven pulley 96 is installed on the steering shaft of each driving wheel 32 and is connected to the driving pulley 94, which is installed on a driving shaft of the swerve motor 84, by the swerve belt 92.

The swerve driving part 80 of the present embodiment may further include a tension maintaining part 97 maintaining tension of the swerve belt 92 to prevent slippage between the driving pulley 94 or the driven pulley 96 and the swerve belt 92, and as a result, malfunctioning in which a moving direction of the movable main body 10 does not match a control signal from the controller due to the driving wheel 32 that has not received the power from the swerve motor 84 can be prevented.

The tension maintaining part 97 of the present embodiment may include a protruding pulley 99 disposed in a direction toward an inner side of the movable main body 10 relative to the driven pulley and having the swerve belt 92 wound therearound to press the swerve belt 92 toward the inner side of the movable main body 10, and a protruding part 98 protruding from the swerve plate 82 to support the protruding pulley 99.

The swerve plate 82 of the present embodiment is disposed to lean toward one side of a lower portion of the movable main body 10 and is disposed not to interfere with a rail plate 52 installed to be able to protrude to a lower side of the movable main body 10.

The swerve belt 92 connected from the swerve plate 82 to the driving wheels 32 may extend in a closed loop shape along an edge of the movable main body 10, and as a result, it is possible to prevent interference between the swerve belt 92 and the rail plate 52 disposed to be movable from a central portion of the movable main body 10 to the lower side thereof.

The swerve driving part 80 of the present embodiment performs a steering operation while the steering shafts of the plurality of driving wheels 32 are connected thereto by the swerve belt 92, and as a result, free movement in various directions is possible with minimum use of a driving module.

The rail driving part 50 of the present embodiment may include the rail plate 52 installed to be able to protrude from the movable main body 10 or retract, a plurality of rail wheels 54 disposed on the rail plate 52, a rail motor 56 providing power to the rail wheels 54, and a rail belt 58 transmitting the power provided from the rail motor 56 to the plurality of rail wheels 54.

In addition, the travel switching part 70 of the present embodiment may include a cylinder member 72 disposed on the movable main body 10, a rod member 74 installed to be able to protrude from the cylinder member 72 and connected to the rail plate 52, and a switching motor 76 switching the power to linear motion, providing the linear motion to the rod member 74, and causing the rod member 74 to protrude from the movable main body 10 or retract.

Accordingly, when the rod member 74 protrudes from the cylinder member 72 due to driving of the switching motor 76, due to the rod member 74 passing through the movable main body 10 and protruding to the lower side, the rail plate 52 protrudes downward, the rail wheels 54 are disposed below the driving wheels 32 such that the movable main body 10 moves upward, and as the rail wheels 54 protruding downward past the driving wheels 32 are seated on the hot water pipe 14, the rail travel is performed.

The rail driving part 50 of the present embodiment may be driven according to topographical features of greenhouses even when the level ground travel is performed, such as when the movable main body 10 passes through a trench with a narrow width, and at this time, due to an operation of the travel switching part 70, the rail driving part 50 protrudes, and travel operations suitable for various topographical features are performed.

A measurement operation for determining whether the arrangement directions of the rail wheels 54 and the arrangement direction of the hot water pipe 14 are the same is performed before the rail travel is performed due to the operation of the rail driving part 50 described above, and when the arrangement directions of the rail wheels 54 and the hot water pipe 14 are different from each other, the arrangement directions of the rail wheels 54 are adjusted by an operation of the steering driving part 100.

The steering driving part 100 of the present embodiment may include a steering plate 102 supporting the cylinder member 72 and rotatably installed on the movable main body 10, and a steering motor 104 having a driving shaft gear-connected to the steering plate 102 to provide forward or reverse power to the steering plate 102.

Accordingly, when power is provided from the steering motor 104, since the steering plate 102 rotates in the forward or reverse direction due to a gear disposed on the driving shaft of the steering motor 104 and gear teeth provided on the steering plate 102 and gear-connected to the driving shaft of the steering motor 104, the arrangement directions of the rail wheels 54 can be adjusted as the cylinder member 72 and the rod member 74, which are supported by the steering plate 102, rotate in the forward or reverse direction.

A control method of a moving robot for greenhouses that is equipped with the multi-layer driving device according to the present embodiment configured as described above includes starting a level ground travel of the movable main body 10 having the travel driving part 30 performing the level ground travel, the rail driving part 50 performing a rail travel, the travel switching part 70 controlling driving of the travel driving part 30 or the rail driving part 50, and the steering driving part 100 changing a direction of the rail driving part 50, in response to the starting of the level ground travel of the movable main body 10 (S10), measuring whether a rail is located on a travel path of the movable main body 10 and determining whether to start the rail travel, in response to the rail being measured as located on the travel path of the movable main body 10 (S20), determining whether arrangement directions of the rail and the rail driving part 50 are different from each other, and in response to the arrangement directions of the rail and the rail driving part 50 being determined as different from each other (S30), transmitting a driving signal to the steering driving part 100 and aligning the arrangement direction of the rail driving part 50 to be the same as the arrangement direction of the rail (S40).

Accordingly, when the moving robot for greenhouses that is equipped with the multi-layer driving device is driven, as the driving wheels 32 rotate due to the power provided from the driving motor 34, the movable main body 10 moves, and a task such as spraying a pesticide to crops is performed, and while the task is in progress, when the movable main body 10 enters a section in which the hot water pipe 14 is disposed, whether the arrangement direction of the hot water pipe 14 and the arrangement directions of the rail wheels 54 are the same is determined by an operation of a detector such as a photosensor disposed on the movable main body 10.

At this time, when the arrangement directions of the rail wheels 54 and the arrangement direction of the hot water pipe 14 are different from each other, a driving signal is transmitted to the steering motor 104 to rotate the steering plate 102 in the forward or reverse direction and control the positions of the rails wheels 54 so that the directions of the rails wheels 54 and the hot water pipe 14 match, and as the swerve belt 92 is driven by the power supplied from the swerve motor 84, the arrangement directions of the plurality of driving wheels 32 are adjusted, and the rail wheels 54 are moved to positions facing the hot water pipe 14.

When the rail wheels 54 move to be disposed at an upper side of the hot water pipe 14 due to the operations described above, the rod member 74 protrudes due to driving of the switching motor 76, the rail wheels 54 move downward and are seated on the hot water pipe 14, and then the movable main body 10 starts the rail travel due to the power provided from the rail motor 56 (S50).

When the starting of the rail travel is performed as described above, determining whether to end the rail travel is performed to determine whether to start the level ground travel (S60).

When the rail travel ends, a step (S70) is performed to determine whether the operation of the multi-layer driving device is finished. If the operation of the multi-layer driving device is not terminated, it returns to the step (S10) of starting the level ground travel and proceeds with the level ground travel and/or the rail travel.

The undescribed reference numeral 12 denotes a case 12 installed on the movable main body 10, the undescribed reference numeral 55 denotes a rail pulley 55 installed on rotating shafts of the rail wheels 54 and around which the rail belt 58 is wound, and the undescribed reference numeral 57 denotes a driving pulley 57 installed on a driving shaft of the rail motor 56 and around which the rail belt 58 is wound.

In this way, it is possible to provide a multi-layer driving device, a moving robot for greenhouses that is equipped with the same, and a control method thereof capable of selectively performing a level ground travel and a rail travel and capable of, when traveling inside a greenhouse in which a hot water pipe is installed, performing the rail travel along a rail formed by the hot water pipe and spraying a nutrient solution while freely moving along trenches formed between crops.

In a multi-layer driving device, a moving robot for greenhouses that is equipped with the same, and a control method of the moving robot for greenhouses according to the present invention, since a travel driving part performing a level ground travel and a rail driving part performing a rail travel are provided, and a travel switching part selectively driving the travel driving part or the rail driving part is provided, there are advantages in that an appropriate travel mode can be provided by determining whether the multi-layer driving device is traveling on a level ground of a greenhouse or traveling along a hot water pipe, the multi-layer driving device can spray nutrient solutions while moving to various positions in the greenhouse, and convenience of a worker can be promoted due to not requiring a manual correction task by the worker.

In addition, in a multi-layer driving device, a moving robot for greenhouses that is equipped with the same, and a control method of the moving robot for greenhouses according to the present invention, since a swerve driving part that is able to switch an advancing direction of a travel driving part is provided, there is an advantage in that the entire greenhouse can be effectively managed by moving the multi-layer driving device while switching a direction of a level ground travel of the multi-layer driving device to various directions.

In addition, in a multi-layer driving device, a moving robot for greenhouses that is equipped with the same, and a control method of the moving robot for greenhouses according to the present invention, since a steering driving part adjusting an advancing direction of a rail driving part is provided, there are advantages in that an alignment operation can be performed to align a direction of the rail driving part and a direction of a hot water pipe before the multi-layer driving device enters a rail formed by the hot water pipe, and malfunctioning in which the rail driving part and the rail are spaced from each other can be prevented when the multi-layer driving device enters the rail.

In addition, in a multi-layer driving device, a moving robot for greenhouses that is equipped with the same, and a control method of the moving robot for greenhouses according to the present invention, since a tension maintaining part maintaining swerve angles of a plurality of driving wheels to be the same so that the plurality of driving wheels swerve in the same direction due to an operation of a swerve driving part and preventing power provided from the swerve driving part from slipping and not being transmitted to the plurality of driving wheels is provided, there is an advantage in that the directions of the plurality of driving wheels can be stably changed while the plurality of driving wheels swerve in the same direction according to a driving signal transmitted from a controller.

In addition, in a multi-layer driving device, a moving robot for greenhouses that is equipped with the same, and a control method of the moving robot for greenhouses according to the present invention, since a steering driving part and a rail driving part are configured to have an integrated structure, there are advantages in that free movement is possible with minimum use of a driving module, and synchronization of the rail driving part and a travel driving part can be provided by an operation of the steering driving part, thereby simplifying the moving robot and providing convenience of control.

In addition, in a multi-layer driving device, a moving robot for greenhouses that is equipped with the same, and a control method of the moving robot for greenhouses according to the present invention, there are advantages in that a level ground travel can be performed by an operation of a rail driving part according to topographical features of a greenhouse in which the moving robot travels, and when a rail travel is performed along a rail, the entry and exit to and from a rail can be stably performed by an operation of the rail driving part.

In addition, in a multi-layer driving device, a moving robot for greenhouses that is equipped with the same, and a control method of the moving robot for greenhouses according to the present invention, since a steering driving part, a swerve driving part, and a travel driving part are installed in a multi-layer structure in a single movable main body, there are advantages in that an alignment operation and a driving operation that are performed at the time of entry or exit to or from a rail can be minimized, and traveling can be stably performed according to greenhouse environments having various topographical features.

The present invention has been described above with reference to one embodiment illustrated in the drawings, but the description is merely illustrative, and those of ordinary skill in the art should understand that various modifications and other equivalent embodiments are possible therefrom.

In addition, although a multi-layer driving device, a moving robot for greenhouses that is equipped with the same, and a control method thereof have been described above as an example, the description is merely illustrative, and a moving robot equipped with the driving device of the present invention and a control method thereof may also be used in products other than the multi-layer driving device, a moving robot for greenhouses that is equipped with the same, and a control method thereof.

Therefore, the true technical protection scope of the present invention should be defined by the claims below.

What is claimed is:

1. A multi-layer driving device comprising:
a travel driving part disposed on a movable main body to perform a level ground travel;
a rail driving part disposed at a different height relative to the travel driving part to perform a rail travel along a rail disposed on a ground surface; and
a travel switching part enabling the level ground travel or the rail travel by causing the rail driving part to protrude toward the ground surface or retract according to whether the rail is located on a movement path of the movable main body.

2. The multi-layer driving device of claim 1, wherein the travel driving part includes:
a plurality of driving wheels disposed on the movable main body;
a driving motor providing power to rotating shafts of the driving wheels; and
a driving switching part controlling an advancing direction and a rotation speed of the power provided from the driving motor and transmitting the power to the rotating shafts of the driving wheels.

3. The multi-layer driving device of claim 2, further comprising a swerve driving part connecting the plurality of driving wheels to each other so that the plurality of driving wheels are disposed in the same direction and swerving the plurality of driving wheels in the same direction to adjust an advancing direction of the movable main body.

4. The multi-layer driving device of claim 3, wherein the swerve driving part includes:
a swerve plate disposed on the movable main body;
a swerve motor disposed on the swerve plate; and
a power transmission part transmitting power provided from the swerve motor to steering shafts of the driving wheels to swerve the plurality of driving wheels in the same direction.

5. The multi-layer driving device of claim 4, wherein the power transmission part includes:
a driving pulley installed on a driving shaft of a swerve switching part connected to the swerve motor;
a driven pulley installed on a swerve shaft of each of the plurality of driving wheels; and
a swerve belt installed to surround the driving pulley and the driven pulley to transmit the power provided from the swerve motor to the plurality of driving wheels.

6. The multi-layer driving device of claim 5, wherein the swerve driving part further includes a tension maintaining part maintaining tension of the swerve belt to prevent slippage between the driving pulley or the driven pulley and the swerve belt.

7. The multi-layer driving device of claim 6, wherein the tension maintaining part includes:
a protruding pulley disposed in a direction toward an inner side of the movable main body relative to the driven pulley and having the swerve belt wound therearound to press the swerve belt toward the inner side of the movable main body; and
a protruding part protruding from the swerve plate to support the protruding pulley.

8. The multi-layer driving device of claim 1, wherein the rail driving part includes:
a rail plate installed to be able to protrude from the movable main body or retract;
a plurality of rail wheels disposed on the rail plate;
a rail motor providing power to the rail wheels; and
a rail belt transmitting the power provided from the rail motor to the plurality of rail wheels.

9. The multi-layer driving device of claim 8, wherein the travel switching part includes:
a cylinder member disposed on the movable main body;
a rod member installed to be able to protrude from the cylinder member and connected to the rail plate; and
a switching motor causing the rod member to protrude from the movable main body or retract.

10. The multi-layer driving device of claim 9, further comprising a steering driving part switching an arrangement direction of a rail switching part while driving the travel switching part in a forward direction or a reverse direction to, when the movable main body enters the rail, align directions of the rail driving part and the rail to be the same.

11. The multi-layer driving device of claim 10, wherein the steering driving part includes:
a steering plate supporting the cylinder member and rotatably installed on the movable main body; and
a steering motor having a driving shaft gear-connected to the steering plate to provide forward or reverse power to the steering plate.

12. A moving robot for greenhouses that is equipped with a multi-layer driving device, including:
a travel driving part disposed on a movable main body to perform a level ground travel;
a rail driving part disposed at a different height relative to the travel driving part to perform a rail travel along a rail disposed on a ground surface; and
a travel switching part enabling the level ground travel or the rail travel by causing the rail driving part to protrude toward the ground surface or retract according to whether the rail is located on a movement path of the movable main body.

13. A control method of a moving robot for greenhouses that is equipped with a multi-layer driving device, the control method comprising:
(a) starting a level ground travel of a movable main body having a travel driving part performing the level ground travel, a rail driving part performing a rail travel, a travel switching part controlling driving of the travel driving part or the rail driving part, and a steering driving part changing a direction of the rail driving part;
(b) in response to the starting of the level ground travel of the movable main body, measuring whether a rail is located on a travel path of the movable main body and determining whether to start a rail travel;
(c) in response to the rail being measured as located on the travel path of the movable main body, determining whether arrangement directions of the rail and the rail driving part are different from each other; and
(d) in response to the arrangement directions of the rail and the rail driving part being determined as different from each other, transmitting a driving signal to the steering driving part and aligning the arrangement direction of the rail driving part to be the same as the arrangement direction of the rail.
